(19) United States
(12) Patent Application Publication
(10) Pub. No.: US 2012/0091785 A1
(43) Pub. Date: Apr. 19, 2012

(54) Wheel insert for aluminum-alloy wheels

(76) Inventor: Ruben Q. Lara, SR., Houston, TX (US)

(21) Appl. No.: 12/925,318

(22) Filed: Oct. 19, 2010

(51) Int. Cl. B60B 27/00; B23P 17/00

(52) U.S. Cl. 301/111.04; 29/527.4

(57) ABSTRACT

The present invention is directed to a wheel insert used with aluminum-alloy vehicle wheels. More specifically, the present invention is directed to a milled, wheel, insert used to modify the original lug bolt pattern of a vehicle wheel to adapt the vehicle wheel for use with almost any vehicle regardless of the number or spacing of lug bolts located on the vehicle's hub.

### FIELD OF THE INVENTION

The present invention is directed to a wheel insert used with aluminum-alloy vehicle wheels, wherein the wheel insert facilitates the modification of the lug bolt pattern of the vehicle wheel, thereby allowing virtually any vehicle wheel to be mounted to any vehicle, regardless of the original lug bolt pattern used with the vehicle.

### BACKGROUND OF THE INVENTION

Automobiles have always been dependent upon wheels for motion. Vehicle wheels are designed in such a manner that every wheel has a specific number and pattern of lug bolt receiving orifices located at the center portion of the wheel. Automobiles are equipped with wheel receiving members called hubs, and most vehicles have four hubs. Each vehicle hub is designed to mate with a specific vehicle wheel. Each hub includes a plurality of lug bolts, wherein the number and placement of the lug bolts creates a particular lug bolt pattern. The lug bolts protrude outwardly from the vehicle hub and are designed to penetrate and extend through the lug bolt receiving orifices in the vehicle wheel. Each lug bolt pattern on the hub has a specific number of lug bolts, i.e., 4, 5, 6 or 8 lug bolts and the lug bolts are arranged on the center portion of the hub in a variety of uniform patterns. Likewise, every vehicle wheel includes an original number and placement of lug bolt receiving orifices, through which the lug bolts of the hub are intended to engage. Once the lug bolts have penetrated and extend through the lug bolt receiving orifices of the wheel, a lug nut is threadedly fastened to the exposed end of each lug bolt to secure the wheel to the hub of the vehicle.

When the vehicle wheel is properly mated with the corresponding lug bolts protruding from the hub of the vehicle, the wheel may then be properly mounted on to the hub.

It is common for owners of vehicles to change or customize the wheels on their vehicles. Vehicle manufacturers often use very different lug bolt patterns to distinguish the wheels manufactured for their automobiles from the wheels manufactured for other vehicle manufacturers. For example, a wheel that mates with the lug bolt pattern of a hub on a GENERAL MOTORS® automobile, will likely not mate with the lug bolt pattern of a hub on a vehicle made by FORD®, CHRYSLER®, HONDA®, TOYOTA®, NISSAN®, etc. The same is true of the other manufacturers.

Further, the owner of a TOYOTA® automobile may want to mount a set of wheels on his or her automobile that were originally intended to mate with a FORD® automobile. Typically, the lug bolt pattern of a TOYOTA® automobile will not align with a wheel intended to mate with a FORD® automobile. Often times a custom wheel manufacturer may not manufacture a particular style of its custom wheels to mate with every brand and/or make of automobile and therefore, some automobile owners are limited as to what type of wheel they can use with their automobile. Occasionally, the owner of an automobile will end up with an extra set of wheels that he or she would like to use on an alternate automobile, but the lug bolt pattern of these wheels does not match up with the lug bolt pattern of the particular automobile. In these instances, the automobile owner is left with an unusable set of automobile wheels, and the owner may have to greatly discount the price of these wheels in order to sell them, or trade them for wheels that he or she can use, or may simply dispose of the extra set of wheels in some other manner.

The present invention wheel insert is used with existing aluminum-alloy vehicle wheels to modify the number and spacing of lug bolt receiving orifices, to allow the modified vehicle wheel to be used with virtually any automobile. This invention provides for the secondary or tertiary use of vehicle wheels, regardless of the make or model of the automobile for which the wheels are to be used.

Therefore a need exists to provide an effective, cost-efficient, and easily installed, wheel insert which can be used to modify the lug bolt receiving orifices of any aluminum-alloy vehicle wheel to provide for the use of said vehicle wheel with virtually any make of automobile.

### SUMMARY OF THE INVENTION

The present invention is directed to a wheel insert for use with aluminum-alloy vehicle wheels. More specifically, the present invention is directed to a wheel insert for use with aluminum-alloy vehicle wheels which are used to modify the placement and number of the lug bolt receiving orifices of the vehicle wheel to allow virtually any vehicle wheel to be used with any vehicle, regardless of the number of lug bolts and the pattern of the lug bolts, on the vehicle hub. The wheel inserts are comprised of a ring-shaped body, having an inner diameter surface, an outer diameter surface and a central annular opening. The inner diameter surface of the wheel insert further includes a first upper chamfer, a second lower chamfer and an axial mid-section which separates the first upper chamfer from the second lower chamfer. The outer diameter surface of the wheel insert also includes a knurled finish and a third lower chamfer.

### BRIEF DESCRIPTION OF THE DRAWINGS

The accompanying drawings which are incorporated into and constitute a part of this specification, illustrate a preferred embodiment of the invention and together with a general description of the invention given above and the detailed description of the preferred embodiment, and any alternative embodiment given below, serve to explain the principals of the invention. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of an aluminum-alloy vehicle wheel in combination with an end mill tool.

FIG. 2 is an enlarged view of the lug bolt receiving orifice pattern of the aluminum-alloy vehicle wheel shown in FIG. 1.

FIG. 3 is a view of the lug bolt receiving orifice pattern of the aluminum-alloy vehicle wheel shown in FIG. 2, in combination with an end mill tool.

FIG. 4 is a perspective view of the present invention wheel insert.

FIG. 5 is a cut-away, perspective view of the modified aluminum-alloy vehicle wheel shown in FIG. 3, wherein a new lug bolt-receiving orifice has been counter bored into the vehicle wheel.

FIG. 6 is a cut-away, perspective view of the modified aluminum-alloy vehicle wheel shown in FIG. 5, further illustrating the installation of the wheel insert into the newly counter-bored lug bolt-receiving orifice.

FIG. 7 is a perspective, cross-section view of the present invention wheel insert.

FIG. 8 is a front view of an end mill tool illustrating the use of a counter bore bit.

FIG. 9 illustrates a wheel insert blank having the same dimensions and thickness as the present invention wheel insert.

FIG. 10 illustrates the modified aluminum-alloy vehicle wheel shown in FIG. 6, wherein a vehicle lug bolt has penetrated and is protruding through the wheel insert. A lug nut is additionally shown in FIG. 10, wherein the lug nut is in axial alignment to threadedly engage the exposed end of the lug nut.

FIG. 11 is a frontal view of a modified aluminum-alloy vehicle wheel illustrating a factory installed, dual-drilled, 5 lug set of original lug bolt receiving orifices and six new lug bolt receiving orifices that have been counter-bored into the vehicle wheel. FIG. 11 also illustrates the insertion of the wheel insert into the 6 new lug bolt receiving orifices.

FIG. 12 is a frontal view of a modified aluminum-alloy vehicle wheel illustrating the factory installed, single-drilled, 6 lug bolt set of original lug bolt receiving orifices and 5 new lug bolt receiving orifices that have been counter-bored into the vehicle wheel. FIG. 12 also illustrates the insertion of the wheel insert into the 5 new lug bolt receiving orifices

FIG. 13 is a frontal view of a modified aluminum-alloy vehicle wheel illustrating the factory installed, single-drilled, 6 lug set of original lug bolt receiving orifices and 6 new lug bolt receiving orifices that have been counter-bored into the vehicle wheel. FIG. 13 also illustrates the insertion of the wheel insert into the 6 new lug bolt receiving orifices.

FIG. 14 is a frontal view of a modified aluminum-alloy vehicle wheel illustrating the factory installed, single-drilled, 5 lug set of original lug bolt receiving orifices and 5 new lug bolt receiving orifices that have been counter-bored into the vehicle wheel. FIG. 14 also illustrates the insertion of the wheel insert into the 5 new lug bolt receiving orifices.

FIG. 15 is a cross-sectional, cutaway view of 15-15′ that illustrates the structure of the new lug bolt-receiving orifice in association with the factory installed original lug bolt-receiving orifice.

FIG. 16 is a cross-sectional, cutaway view of 16-16′ that illustrates the structure of the new lug bolt-receiving orifice further illustrating the insertion of the wheel insert therein.

### DETAILED DESCRIPTION OF THE INVENTION

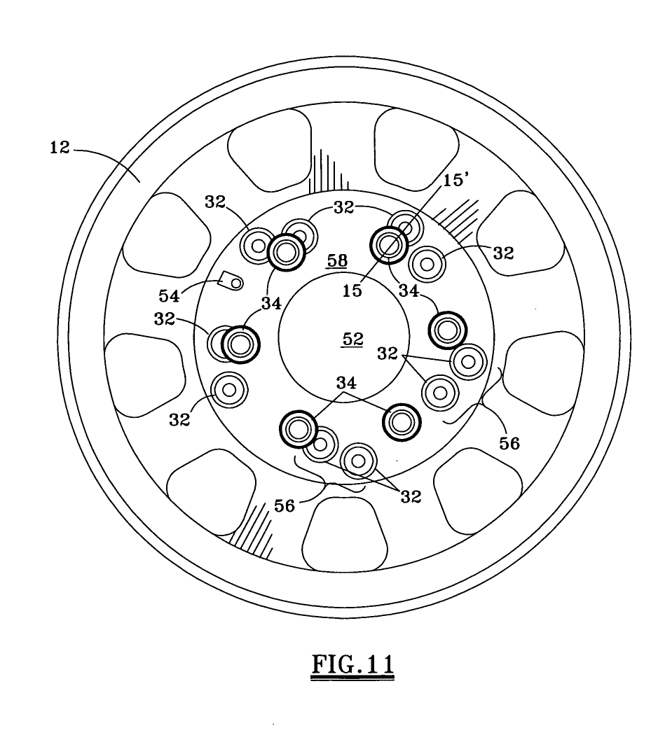

A preferred embodiment wheel insert 10 for use with an aluminum-alloy wheel 12 is shown in FIGS. 4 and 7. The wheel insert 10 is preferably comprised of 1018 hot rolled steel or similar hardened steel material that is a much harder material as compared to the relatively soft aluminum-alloy material comprising the wheel 12. The wheel insert 10 generally includes a ring-shaped body 14, having an inner diameter surface 16, an outer diameter surface 18 and a central annular opening 20. The inner diameter surface 16 of the wheel insert 10 further includes a first upper chamfer 22, a second lower chamfer 24 and an axial mid-section 26 which separates the first upper chamfer 22 from the second lower chamfer 24. The second lower chamfer 24 is formed during the polishing or de-burring process of manufacturing the wheel insert 10. The outer diameter surface 18 of the wheel insert 10 includes a knurled finish 28 and a third lower chamfer 30. The axial mid-section 26 of the inner diameter surface 16 of the wheel insert 10, generally is in parallel, axial alignment with the outer diameter surface 18. The diameter D₁ of the central annular opening 20 is approximately ⅝ inch, which is just slightly wider than the standard width of a common lug bolt 31 shown in FIG. 10. The outer diameter D₂ of the ring-shaped body 14 is approximately 1 inch. The length of the outer diameter D₂ of the ring-shaped body 14 is not as critical as the length of the diameter D₁ of the central annular opening 20, however the narrower the outer diameter D₂ of the ring-shaped body 14, the narrower a new bore 34 will be required to be made in the wheel 12, and the smaller the bore diameter will result in less aluminum-alloy material being bored out of the wheel 12. Removing as little as possible aluminum-alloy material during the boring and counter-boring process will result in preserving more integrity and strength of the wheel 12. The preferred thickness T of the ring-shaped body 14 is in the range of ¼ inch to 5/16 inch, but can vary depending upon the particular application.

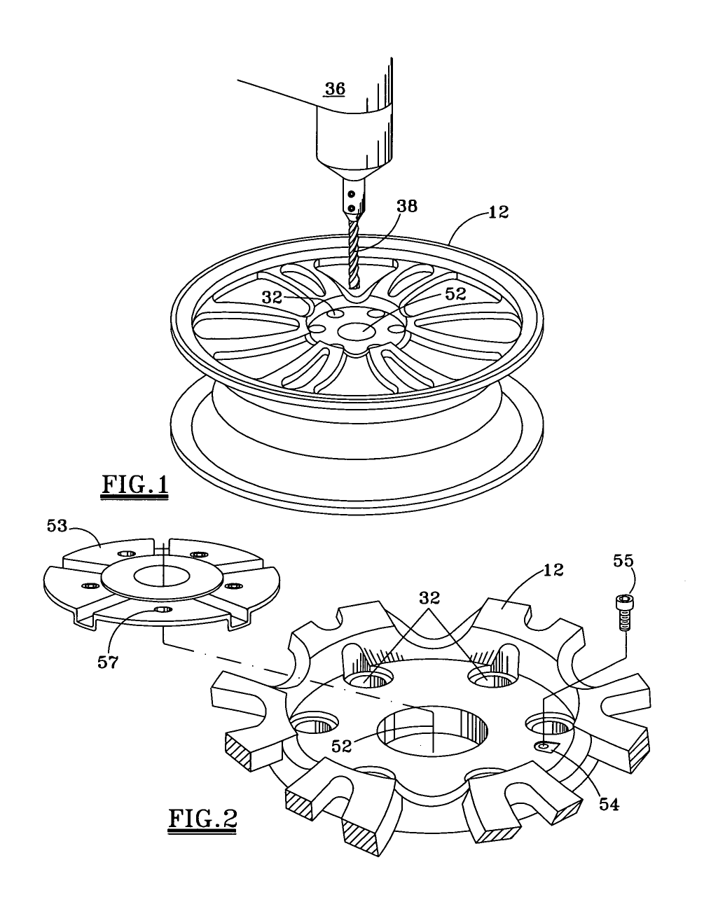

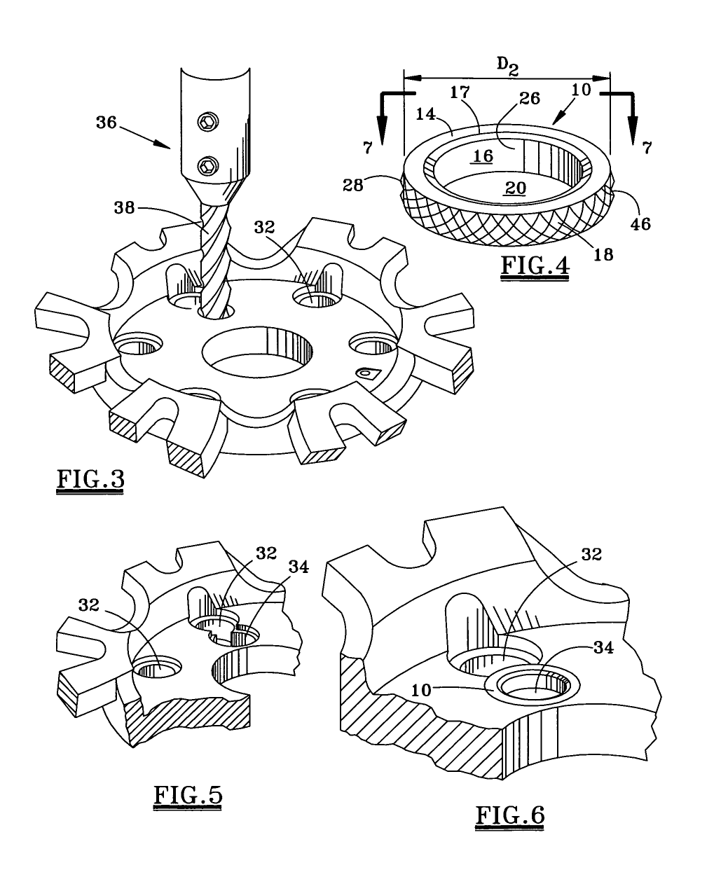

As previously discussed herein, and illustrated in FIGS. 1-3 and FIGS. 11-14, original equipment manufacturer (OEM) vehicle wheels 12 include an initial number and particular spacing of original lug bolt receiving orifices 32. When it is desired that the vehicle wheel 12 is to be modified to add a new set of lug bolt receiving orifices 34 so that the wheel 12 will mate with a hub (not shown) of a different vehicle (not shown), the new lug bolt receiving orifices 34 must be carefully counter-bored into the wheel 12.

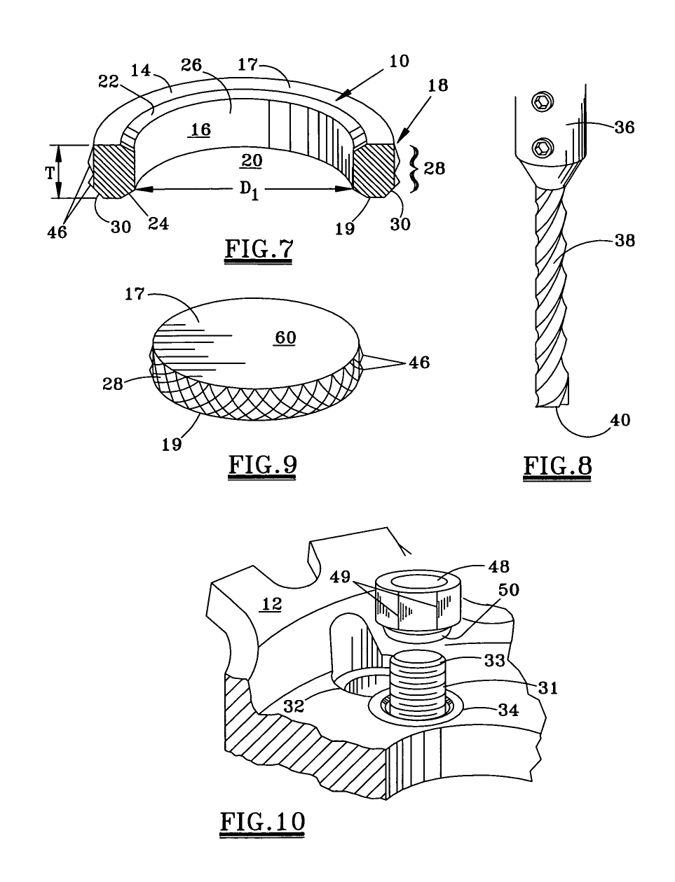

The rotating head of an end mill machine 36, shown in FIG. 1, is typically used to bore into the vehicle wheel 12 to create the new lug bolt-receiving orifice 34. The end mill machine 36 employs a counter-bore tool 38, as illustrated in FIG. 8, rather than a traditional, tapered drill bit (not shown). The counter-bore tool 38 has a flat-faced end 40, instead of a tapered end commonly used with drill bits (not shown). The benefit of using a counter-bore tool 38 is that the flat-faced end 40 will not “walk” or “drift” with respect to the surface of the wheel 12, while the a new lug bolt receiving orifice 34 is being bored. Due to the substantial expense of aluminum-alloy vehicle wheels 12 and the inability to remove or repair damage made to aluminum-alloy wheels, it is vitally important that the new lug bolt receiving orifice 34 be precisely bored into the wheel 12, with as little damage to the wheel 12 as possible.

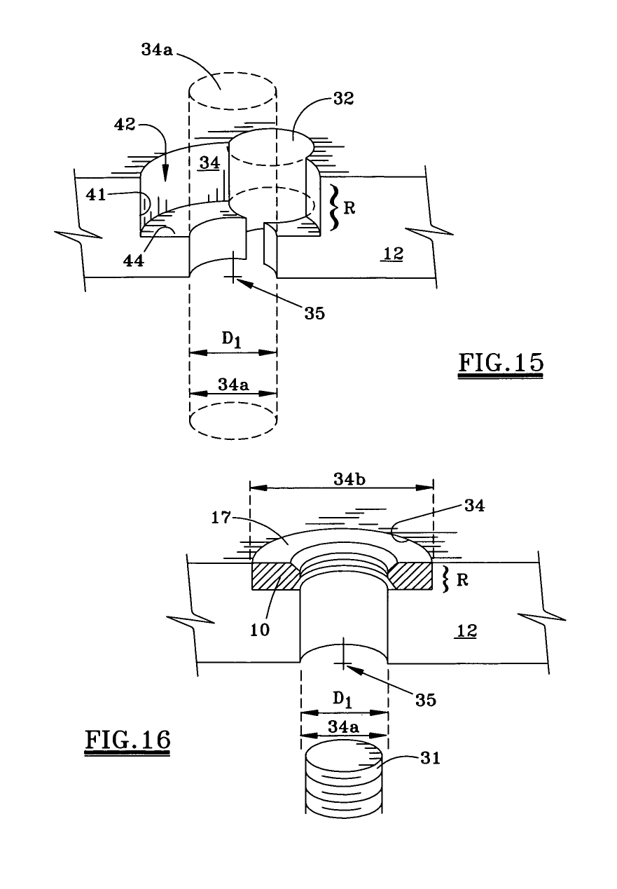

In order to bore a new lug bolt receiving orifice 34, a first or pilot bore 34a is made into the wheel 12, as depicted in FIGS. 1-3 and 15, wherein the diameter D₁ of the counter-bore tool 38 is approximately ⅝ inch and is generally slightly larger as compared to the diameter of the common lug bolt 31. The first bore 34a completely penetrates the wheel 12, as shown in FIGS. 15-16. Thereafter, a larger diameter, second bore or counter-bore 34b is made in an axial center 35 of the first bore 34a, wherein the counter-bore tool 38 used to make the second bore 3b is approximately 1 inch in diameter. The diameter of the second bore 34b can be in the range of 1-1.25 inch. The second bore 34b bores into the surface of the wheel 12 at a depth in the range R of 0.25 inch to 0.35 inch, thereby only partially penetrating the wheel 12, in distinction to the first bore 34a. By the partial penetration of the second bore 34b; the second bore 34b creates a cylindrical gland area 42 having a cylindrical wall 41 and a seat portion 44 in the wheel 12.

Once the second bore 34b has been completed, the wheel insert 10 can then be inserted into the gland area 42 and thereafter the wheel insert 10 is mechanically pressed in flush contact with the seat portion 44 using a hydraulic press (not shown). The knurled finish 28 of the outer diameter 18 of the wheel insert 10, includes a plurality of outwardly extending teeth 46. The teeth 46 protrude outwardly, away from the outer diameter 18 surface approximately 0.015 inch. The teeth 46 are created during the knurling process of the manufacture of the wheel insert 10. As the wheel insert 10 is pressed into the cylindrical gland area 42, the teeth 46 “bite” or “wedge” into the wall area 41 of the gland 42 and anchor the wheel insert 10 against the seat portion 44 as shown in FIG. 16. With the wheel insert 10 engaged to the new lug bolt receiving orifice 34 of the wheel 12, the lug bolt 31 can then be inserted into the first bore 34a and through the central annular opening 20 of the wheel insert 10 as depicted in FIGS. 10 and 16. Once the lug bolt 31 has been fully disposed through the new lug bolt-receiving orifice 34, a lug nut 48 can then be threadedly affixed to the receiving end 33 of the lug nut 31 to secure the wheel 12 to the hub (not shown) of the automobile (not shown). The wheel insert 10 is inserted into each of the new lug bolt receiving orifices 34 to allow a lug nut 48 to be mated against the first upper chamfer seating surface 22 of the wheel insert 10, to avoid damage to the vehicle wheel 12. If not for the implementation of the steel wheel insert 10, the plurality of hardened steel grip edges 49 of the lug nut 48 would gouge and irreparably damage the much softer aluminum-alloy material comprising the wheel 12 and would deform and damage the new lug bolt receiving orifice 34, ultimately rendering the vehicle wheel 12 unserviceable.

The first upper chamfer 22 of the wheel insert 12 is generally milled at a 60-degree angle to mate with a receiving end 50 of the lug nut 48. The third lower chamfer 30 is created during the manufacture of the wheel insert 10 when the milled wheel insert 10 is separated from the bar stock and provides no utilitarian function.

The new lug bolt receiving orifice 34 is generally bored near or slightly off-set to the original lug bolt receiving orifice 32 as depicted in FIGS. 5, 6, 11-14. Typically, original lug bolt receiving orifices 32 and new lug bolt receiving orifices 34 are located at intervals of 4.5 inches, 4.75 inches and 5 inches from a center point 52 of the wheel 12, as depicted in FIGS. 11-14. For wheels 12 that include a center cap 53, the new lug bolt receiving orifices 34 are typically offset from the original lug bolt receiving orifices 32 in a side-by-side manner as shown in FIGS. 11-13 and, in some instances, the new lug bolt receiving orifices 34 may overlap a small portion of the original lug bolt receiving orifices 32, as depicted in FIGS. 5-6, and 11-14.

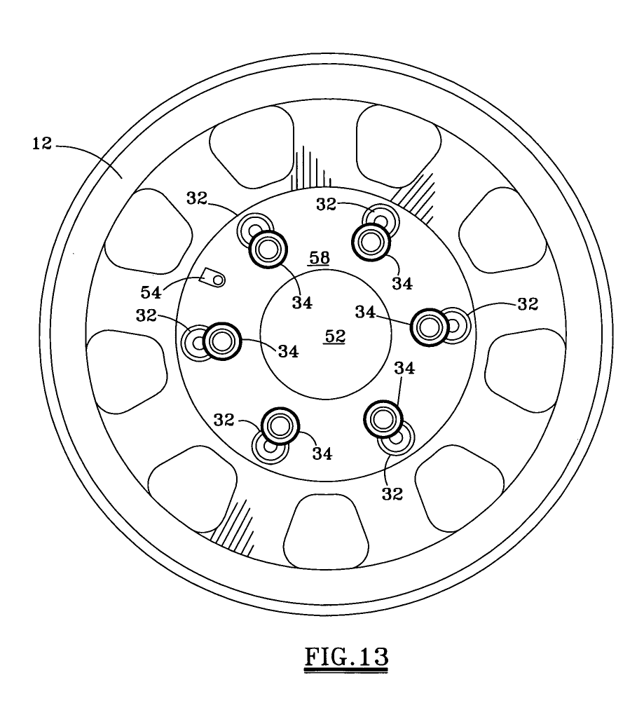

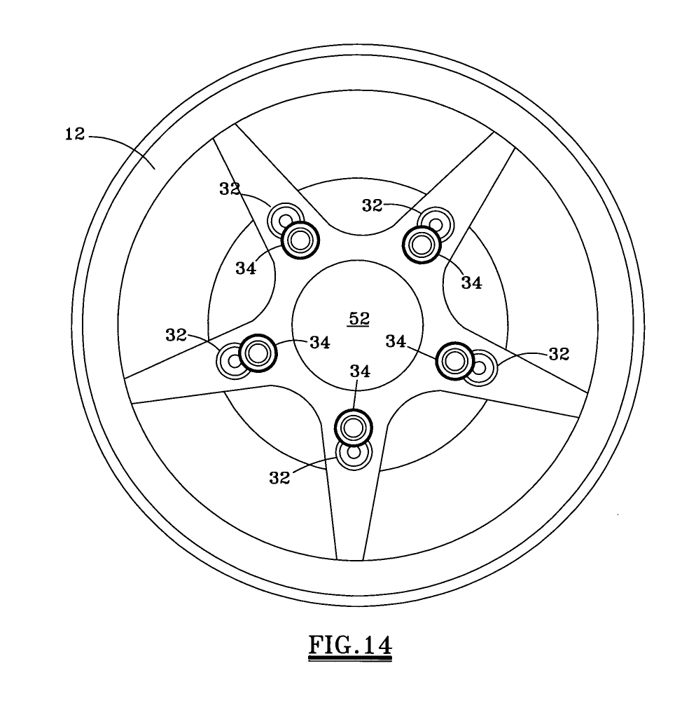

Many aluminum-alloy vehicle wheels 12 require the use of the center cap 53 which “covers” or “hides” the lug bolt receiving orifices 32, 34 and lug nuts 48. The center cap 53 is secured to the vehicle wheel 12 using a threaded bolt 55 wherein the threaded bolt 55 penetrates an orifice 57 in the center cap 53 and threadedly engages a center cap screw receiving hole 54. The center cap screw receiving hole 54 is depicted on the vehicle wheel 12 in FIGS. 2-3 and 11-14. The center cap screw receiving hole 54 greatly limits the placement of the new lug bolt receiving orifices 34, due to the necessity of keeping the center cap screw receiving hole 54 in tact and undamaged to secure the center cap 53 to the vehicle wheel 12.

Where the vehicle wheel 12 does not require the use of a center cap (not shown) as depicted in the wheels 12 illustrated in FIGS. 11-14, the new lug bolt receiving orifices 34 can either be offset in a radial manner or a side-by-side manner as shown in FIGS. 13-14.

As illustrated in FIGS. 11-13, many aftermarket aluminum-alloy wheels 12 often include dual sets 56 of originally manufactured lug bolt receiving orifices 32 which allow the wheel 12 to be mounted to multiple vehicles (not shown) having different sets and sizes of lug bolt patterns. The inclusion of multiple unused lug bolt receiving orifices 32, 34 in a center portion 58 of the wheel 12 may not, however, always be generally considered aesthetically pleasing. The creation of multiple new lug bolt receiving orifices 34 for the placement of the present invention wheel insert 10, only adds to the un-aesthetic look of the center portion of the wheel 12 and generally requires the use of the center cap 53 to conceal the multiple sets of lug bolt receiving orifices 32, 34.

Another advantage to using the wheel insert 10 is that a wheel 12 which is manufactured and designed for use with a five lug bolt patterned hub (not shown) can be modified for use with a hub (not shown) having a six lug bolt pattern. FIG. 11 specifically illustrates an originally manufactured, dual-drilled, five lug bolt patterned wheel 12 (having two distinct and separately sized sets 56 of five lug bolt receiving orifices), wherein six new lug bolt receiving orifices 34 have been bored into the wheel 12 and a wheel insert 10 has been pressed into each newly bored lug bolt receiving orifice 34, in order to mate the wheel 12 with a six lug bolt patterned hub (not shown). After the wheel 12 has been appropriately modified with the new lug bolt receiving orifices 34 and a wheel insert 10 has been pressed into each new lug bolt receiving orifice 34, the wheel 12 is mounted onto the hub (not shown) of an automobile and lug nuts 48 are used to affix the wheel 12 to the lug bolts 31 of the hub (not shown). Afterwards, the center cap 53 is placed over the center portion 58 of the wheel 12 and the threaded fastener 55 is inserted through center cap 53 and threadedly engages the center cap screw receiving hole 54 of the wheel 12, thereby affixing the center cap 53 to the wheel 12.

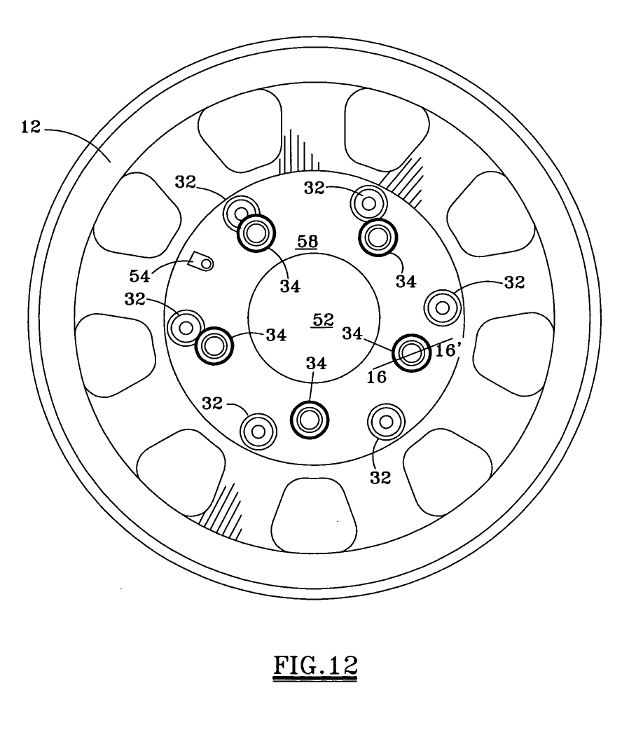

FIG. 12 illustrates a wheel 12 that has been originally manufactured with a single-drilled, six lug bolt pattern. The wheel 12, in FIG. 12, has further been modified by boring five new lug bolt receiving orifices 34, to allow the wheel 12 to be mounted on to a hub having a five lug bolt pattern. The wheel 12 shown in FIG. 12 also requires the use of the center cap 53 to conceal the lug bolt receiving orifices 32, 34 after the wheel 12 has been mounted to a vehicle (not shown).

FIG. 13 illustrates a wheel 12 that has been originally manufactured with a single-drilled, six lug bolt pattern, similar to the wheel in FIG. 12. The wheel 12, illustrated in FIG. 12, has however been modified by boring six new lug bolt receiving orifices 34 to fit a smaller-radius, six lug bolt pattern, unlike the wheel 12 in FIG. 12. The six new lug bolt receiving orifices 34 illustrated in FIG. 13 must be bored in radial alignment with the original lug bolt receiving orifices 32 due to the placement of the center cap screw receiving hole 54 of the wheel 12. The location of the center cap screw receiving hole 54 does not allow the new lug bolt receiving orifices 34 to be offset from the originally manufactured lug bolt receiving orifices 32. To do so would damage the center cap screw receiving hole 54 and the center cap 53 would not be able to be affixed to the wheel 12.

FIG. 14 illustrates a wheel 12 that has been originally manufactured with a single-drilled, five-lug bolt pattern and has been modified by boring five new lug bolt receiving orifices 34 to fit a smaller radius five lug bolt pattern. This wheel 12 has five exposed original lug bolt receiving orifices 32. This wheel 12 does not require the use of a center cap 53 and consequently does not include the center cap screw receiving hole 54, unlike the wheels 12 shown in FIGS. 11-13. In attempting to maintain as much of the aesthetic attractiveness of the modified wheel 12 as possible and without the ability to conceal any of the lug bolt receiving orifices 32, 34 behind a center cap 53, the new lug bolt receiving orifices 34 are bored in radial alignment to, and generally overlapping with, the original lug bolt receiving orifices 32.

FIG. 9 illustrates a wheel insert blank 60. The wheel insert blank 60 is constructed of same material as the wheel insert 10 and has the same general outer dimensions and thickness as the wheel insert 10. The wheel insert blank 60 is a solid, disc-shaped body 60 and is designed for insertion into the new lug bolt receiving orifice 34 to fill the orifice 34 when it is no longer wanted or needed. The wheel insert blank 60 also includes a knurled outer diameter finish 28 having a plurality of teeth 46 which “bite” into the gland area 42 to secure and lock the wheel insert blank 60 in the new lug bolt receiving orifice 34. The wheel insert blank 60 provides additional strength and integrity to the wheel 12 by “filling-in” the un-needed new lug bolt receiving orifices 34 when the originally drilled lug bolt receiving orifices 32 are used, rather than the new lug bolt receiving orifices 34.

Thus the use of the wheel insert 10 in combination with aluminum-alloy wheels 12, can provide for up to three separate and distinct sets of lug bolt receiving orifices 32,34 for the mounting of a vehicle wheel 12 to virtually any vehicle (not shown).

The method of machining the wheel insert 12 for use in the newly-bored lug bolt-receiving orifice 34 in the aluminum-alloy vehicle wheel 12, includes the first step of “knurling” or adding the teeth 46 to the outer diameter surface 18 of a length of blank, round, 1018 hot rolled steel bar stock (not shown). The knurling process includes adding of a plurality of grooves (not shown) that are cut into the outer diameter surface 18 of the bar stock (not shown) in a twisted or rifling manner. The second step includes facing or grinding a flat top surface 17 of the wheel insert 10 to provide the 60 degree angled first upper chamfer 22. The third step includes drilling the ⅝″ central, axial, annular opening 20 through the axial middle or center point of the bar stock member thereby producing an inner diameter surface 16 of the wheel insert 10. The fourth step includes parting or separating the newly manufactured wheel insert 10 from the remaining portion of the knurled, blank, round bar stock (not shown) to separate the completed wheel insert 10 and creating a flat bottom surface 19 and also creating the third chamfer 30 during this step. The fifth step includes de-burring all of the rough edges of the completed wheel insert 10. During the de-burring step, the second chamfer 24 is created. The sixth step includes plating the entire surface of the wheel insert 10 with a zinc coating to reduce the incidence of corrosion.

It will be appreciated that these and other embodiments may be provided for a wheel insert 10 for use with aluminum-alloy wheels, and it should be understood that within the scope of the appended claims, the apparatus might be practiced other than as specifically described herein. Having described the invention above, various modifications of the techniques, procedures and materials will be apparent to those skilled in the art. It is intended that all such variations within the scope and spirit of the appended claims be embraced thereby.

What is claimed is:

1. A wheel insert, comprising:
a ring-shaped body having an inner diameter surface, an outer diameter surface, a flat top surface, a flat bottom surface, and a central, annular opening defined by the inner diameter surface;
the inner diameter surface further having a first upper chamfer proximal to the flat top surface, a second lower chamfer proximal to the flat bottom surface and an axial mid-section separating the upper chamfer from the lower chamfer, wherein the surface alignment of the axial mid-section is generally parallel as compared to the outer diameter surface; and
the outer diameter surface generally having a knurled finish and a third lower chamfer proximal to the bottom flat surface.

2. The wheel insert, as described in claim 1, wherein the ring-shaped body is adapted for fitted insertion in a newly counter-bored orifice in a vehicle wheel.

3. The wheel insert, as described in claim 2, wherein the diameter of the central, annular opening is sized to allow a lug bolt to enter and extend there through.

4. The wheel insert, as described in claim 3, wherein the upper chamfer is machined at a 60 degree angle to mate with an engaging surface of a lug nut.

5. The wheel insert, as described in claim 4, wherein the ring-shaped body is hydraulically pressed into the newly counter-bored orifice in the vehicle wheel.

6. The wheel insert, as described in claim 5, wherein the knurled finish of the outer diameter surface includes a plurality of outwardly protruding teeth, such that when the wheel insert is hydraulically pressed into the newly counter-bored orifice, the teeth anchor into an inner surface wall of the newly counter-bored orifice to fixedly engage the wheel insert with the vehicle wheel.

7. The wheel insert, as described in claim 6, wherein the insert is milled from blank, round bar stock steel comprised of 1018 hot rolled steel.

8. The wheel insert, as described in claim 7, wherein the milled wheel insert is zinc plated.

9. A wheel insert, comprising:
a ring-shaped body having an inner diameter surface, an outer diameter surface, and a central, annular opening defined by the inner diameter surface;
the inner diameter surface further having a first upper chamfer, a second lower chamfer; and
the outer diameter surface generally having a knurled finish.

10. The wheel insert, as described in claim 9, wherein the ring shaped-body further comprises a flat top surface and flat bottom surface.

11. The wheel insert, as described in claim 10, wherein the first upper chamfer is proximal to the flat top surface, a second lower chamfer is proximal to the flat bottom surface and inner diameter surface further comprising an axial mid-section separating the first upper chamfer from the second lower chamfer.

12. The wheel insert, as described in claim 11, wherein the knurled finish further comprises a plurality of outwardly protruding teeth.

13. The wheel insert, as described in claim 12, wherein the ring-shaped body is adapted for fitted insertion into a newly counter-bored orifice in the vehicle wheel and the plurality of outwardly protruding teeth engage into a wall area of a cylindrical gland to anchor the wheel insert within the cylindrical gland.

14. A method of machining a wheel insert, the method comprising the steps of:
knurling an outer diameter surface of a length of blank, round bar stock,
facing the top surface of the wheel insert to provide the 60 degree angled first upper chamfer,
drilling a ⅝ inch diameter, central, axial, annular opening through the bar stock member thereby producing an inner diameter surface of the wheel insert,
parting the wheel insert from the remaining portion of the blank, round bar stock to separate the completed wheel insert and creating the second and third chamfer during said step,
de-burring the edges of the completed wheel insert; and
plating the surface of the wheel insert with a zinc coating.

15. A wheel insert blank for use in a newly-bored lug bolt-receiving orifice, bored into an aluminum-alloy vehicle wheel, the wheel insert blank comprising:
a solid, disc-shaped body, said body having an outer diameter surface, a flat top surface, a flat bottom surface, wherein the outer diameter surface generally includes a knurled finish.

16. The wheel insert blank, as described in claim 15, wherein the knurled finish further comprises a plurality of outwardly protruding teeth.

17. The wheel insert blank, as described in claim 16, wherein the solid, disc-shaped body is adapted for fitted insertion into a newly counter-bored orifice in the vehicle wheel and the plurality of outwardly protruding teeth engage into a wall area of a cylindrical gland to anchor the wheel insert within the cylindrical gland.
